(19) United States
(12) Patent Application Publication
(10) Pub. No.: US 2022/0200301 A1
(43) Pub. Date: Jun. 23, 2022

(54) PLUG-IN POWER SUPPLY FOR WEARABLE ELECTRONIC DEVICE AND WEARABLE ELECTRONIC DEVICE HAVING THE SAME

(71) Applicants: DANIEL WANG, TAIPEI (TW); LI-YUAN WANG, TAIPEI (TW)

(72) Inventors: DANIEL WANG, TAIPEI (TW); LI-YUAN WANG, TAIPEI (TW)

(21) Appl. No.: 17/643,705

(22) Filed: Dec. 10, 2021

(30) Foreign Application Priority Data
Dec. 22, 2020 (TW) 109145867

(51) Int. Cl. H02J 7/00; H02J 50/10; H02J 50/40

(52) U.S. Cl. CPC H02J 7/0044; H02J 50/40; H02J 7/0013; H02J 50/10

(57) ABSTRACT

A wearable electronic device includes a body and a plug-in power supply. The body is provided with a first battery and a first induction coil or a connecting port electrically connected to the first battery. The plug-in power supply is provided with a carder for wearing the body on a wearer's wrist, at least one second battery disposed in the carder, and a second induction coil or a connector disposed in the carrier or extends outside the carrier and electrically connected to the second battery. The first battery absorbs electric power from the second battery when the second induction coil is coupled to the first induction coil or the connector is connected to the connecting port.

### BACKGROUND OF THE INVENTION

### 1. Field of the Invention

The present invention relates to a plug-in power supply for a wearable electronic device and a wearable electronic device having the same.

### 2. Description of the Prior Art

More and more entertainment, work, social contact, communication, sports and health management can be achieved through wearable electronic devices such as smart watches, smart wristbands and so on. However, as the application scope of the wearable electronic device expands, the function becomes more and more powerful, and the use time continues to grow, but the acceptable battery size and weight of the wearable electronic device are often limited, which also limited the capacity of the battery, leading to the battery capacity carried by the wearable electronic device is often unable to meet the needs of a large or long time of use. In this case, the wearable electronic device will have to use an external power supply to continue to function.

There are two kinds of external power sources: fixed power supply and mobile power pack (power bank). Fixed power supply includes wall outlet and electronic equipment with USB port, such as, desktop computer, notebook computer, tablet computer and so on. Mobile power pack is usually a rechargeable secondary battery. The fixed power supply can be charged only when the wearable electronic device is removed from the user. As for the mobile power pack, although it can be carried with you, it can only be placed in handbags, backpacks, travel bags and other personal belongings. When needed, it can be taken out and connected to the wearable electronic device through a connecting line. It can not be directly attached to the user to transmit power to the wearable electronic device, so it is not convenient to carry and use the mobile power pack.

### SUMMARY OF THE INVENTION

It is therefore an object of the present invention is to provide a plug-in power supply that can be attached to a wearable electronic device to meet the needs of a large or long time of use.

It is another object of the present invention is to provide a wearable electronic device with a plug-in power supply that gives the wearable electronic device a more lasting endurance.

According to present invention, a plug-in power supply for a wearable electronic device may include a carrier being worn on a wearer's wrist; at least one battery being disposed in the carrier; and an induction coil or a connector being disposed in the carrier or extended outside the carrier and electrically connected to the battery, the induction coil or the connector transmitting electric power to the wearable electronic device. Wherein the carrier is one of the following carriers a to f:

a. the carrier is belt-shaped, both sides of the carrier are defined with a perforating hole, respectively, the wearable electronic device passes through the perforating holes to overlap with the carrier, so as to be kept on the carder;

b. the carder is C-shaped and is outwardly defined with a groove extending towards both ends thereof, the wearable electronic device is embedded in the groove so as to be kept on the carrier;

c. the carrier is C-shaped and is defined with a recess in the middle thereof, the wearable electronic device is embedded in the recess so as to be kept on the carrier;

d. the carrier is ring-shaped and is defined with a recess in the middle thereof, the wearable electronic device is embedded in the recess so as to be kept on the carder;

e. the carder is C-shaped, and is provided with mechanisms that can be combined with each other in both ends thereof and a recess in the middle thereof, the wearable electronic device is embedded in the recess so as to be kept on the carder; and

f. the carder is belt-shaped and is provided with mechanisms that can be combined with each other in both ends thereof.

According to present invention, a wearable electronic device may include a body having a first battery and a first induction coil or a connecting port electrically connected to the first battery; a strap being connected to the body, so as to wear the body on a wearers wrist; and a plug-in power supply including a carder worn on the wearers wrist, at least one second battery being disposed in the carder, and a second induction coil or a connector being disposed in the carder or extends outside the carder and electrically connected to the second battery, the second induction coil or the connector transmitting electric power of the second battery to the first induction coil or the connecting port, so as to supplement the electric power of the first battery. Wherein the carder is one of the following carders a to c:

a. the carder is belt-shaped, both sides of the carder are defined with a perforating hole, respectively, both ends of the strap pass through the perforating holes to overlap with the carrier, so as to make the body kept on the carrier;

b. the carrier is C-shaped and is outwardly defined with a groove extending towards both ends thereof, the body and the strap are embedded in the groove so as to be kept on the carrier; and

c. the carrier is belt-shaped and is provided with r mechanisms that can be combined with each other in both ends thereof.

In another embodiment, a wearable electronic device may include a body having a first battery and a first induction coil or a connecting port electrically connected to the first battery; and a plug-in power supply including a carrier worn on a wearer's wrist, at least one second battery being disposed in the carrier, and a second induction coil or a connector being disposed in the carrier or extends outside the carder and electrically connected to the second battery, the second induction coil or the connector transmitting electric power of the second battery to the first induction coil or the connecting port, so as to supplement the electric power of the first battery. Wherein the carrier is one of the following carriers a to c:

a. the carder is C-shaped and is defined with a recess in the middle thereof, the body is embedded in the recess so as to be kept on the carder;

b. the carder is ring-shaped and is defined with a recess in the middle thereof, the body is embedded in the recess so as to be kept on the carder; and

c. the carder is C-shaped, and is provided with mechanisms that can be combined with each other in both ends thereof and a recess in the middle thereof, the body is embedded in the recess so as to be kept on the carrier.

In some embodiments, the body is provided with a sensor, the carrier is defined with a window hole facing the sensor.

The effect of the present invention is that the plug-in power supply can be attached to the wearable electronic device, which can provide a more lasting endurance of the wearable electronic device and meet the needs of a large or long time of use.

The present invention will become more obvious from the following description when taken in connection with the accompanying drawings, which show, for purpose of illustrations only. the preferred embodiments in accordance with the present invention.

### BRIEF DESCRIPTION OF THE DRAWINGS

FIG. 1A is a perspective view of a wearable electronic device in accordance with a first embodiment of the present invention.

FIG. 1B is an exploded view of FIG. 1A.

FIG. 2A is a perspective view of a wearable electronic device in accordance with a second embodiment of the present invention.

FIG. 2B is an exploded view of FIG. 2A.

FIG. 3A is a perspective view of a wearable electronic device in accordance with a third embodiment of the present invention.

FIG. 3B is an exploded view of FIG. 3A.

FIG. 3C is a perspective view of a wearable electronic device similar to that of FIG. 3A.

FIG. 3D is an exploded view of FIG. 3C.

FIG. 4A is a perspective view of a wearable electronic device in accordance with a fourth embodiment of the present invention.

FIG. 4B is an exploded view of FIG. 4A.

FIG. 5A is a perspective view of a wearable electronic device in accordance with a fifth embodiment of the present invention.

FIG. 5B is a perspective view of a wearable electronic device similar to that of FIG. 5A.

### DETAILED DESCRIPTION OF THE PREFERRED EMBODIMENTS

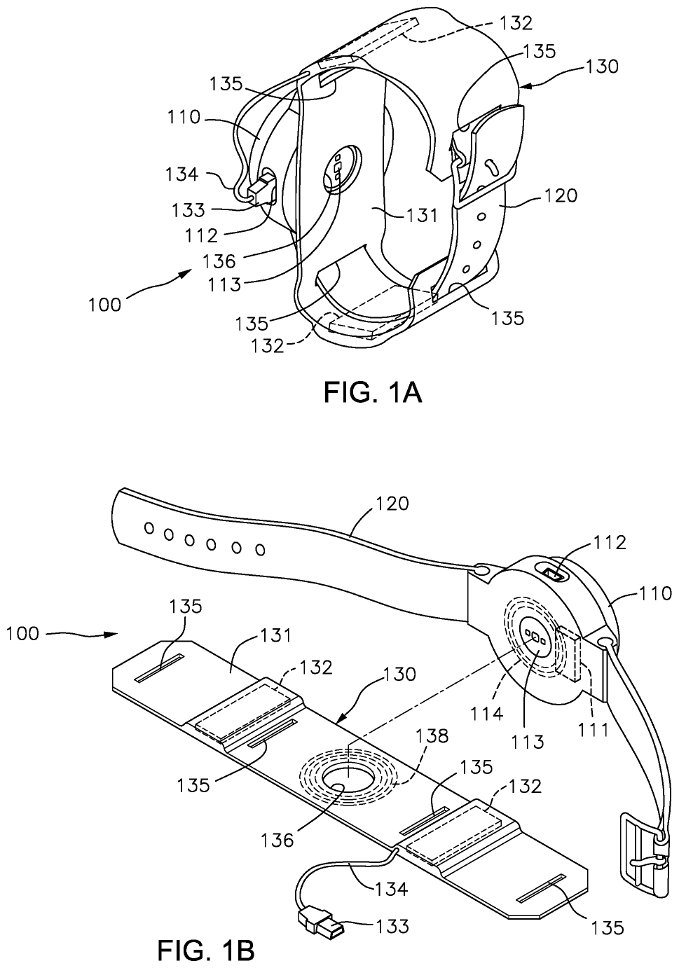

Referring to FIGS. 1A and 1B, a wearable electronic device 100 in accordance with a first embodiment of the present invention comprises a body 110 having a first battery 111 for supplying the electric power required for the operation of the wearable electronic device 100 and a connecting port 112 electrically connected to the first battery 111.

The wearable electronic device 100 also includes a strap 120 connected to the body 110. The strap 120 is made of materials such as fluoroelastomer, leather, webbing, metal etc., so that the strap 120 is flexible, and both ends of the strap 120 are provided with mechanisms such as magnets, buckles, Velcro™ etc. (not numbered) and can be combined with each other, so as to wear the body 110 on a wearer's wrist.

The wearable electronic device 100 is further provided with a plug-in power supply 130 having a carrier 131. In the present embodiment, the carrier 131 is belt-shaped, both sides of the carrier 131 are defined with a perforating hole 135, respectively, both ends of the strap 120 pass through the perforating holes 135 to overlap with the carrier 131, so as to make the body 110 kept on the carrier 131. A window hole 136 is defined in the middle of the carrier 131, so that a sensor 113 mounted on the body 110 can detect the heart rate, blood pressure, blood oxygen and sleep state of the wearer through the window hole 136 for health management.

The plug-in power supply 130 further includes at least one second batten 132 disposed in the carrier 131, and a connecting line 134 electrically connected to the second battery 132 and provided with a free end having a connector 133. When the connector 133 is connected to the connecting port 112, the electric power of the second batten 132 can be transmitted to the first battery 111, so as to extend the disposable time of the wearable electronic device 100 and reduce the inconvenience of frequent charging. Connecting the connector 133 to a mobile power pack or a charger (not shown) can supply the electric power to the second battery 132.

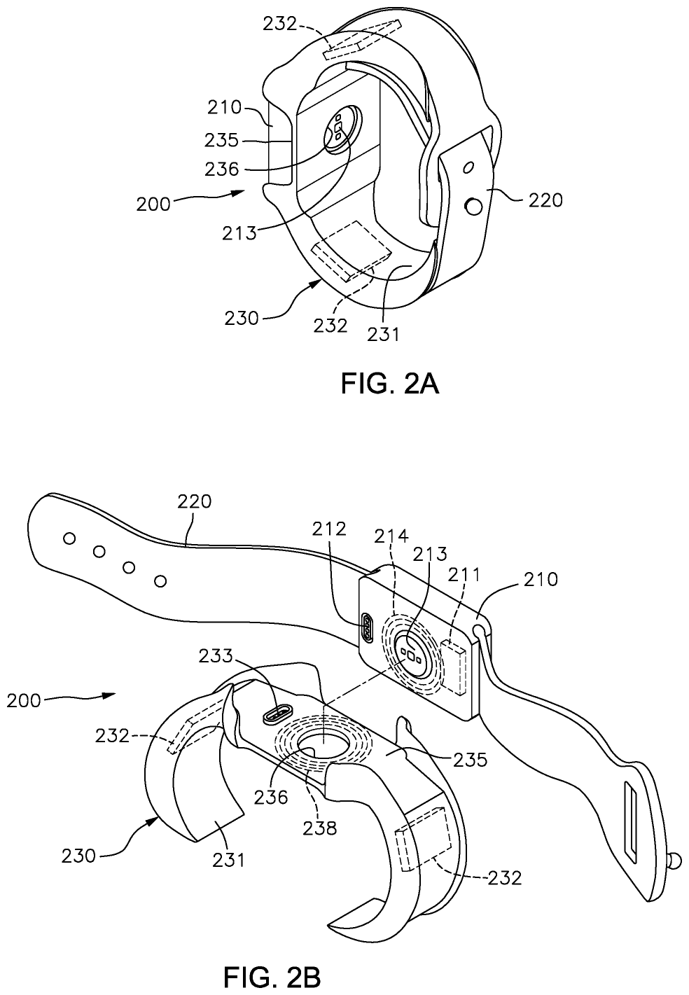

Referring to FIGS. 2A and 2B, a wearable electronic device 200 in accordance with a second embodiment of the present invention comprises a body 210, a strap 220 and a plug-in power supply 230. The body 210 is provided with a first battery 211, a connecting port 212 electrically connected to the first batten 211 and a sensor 213. Both ends of the strap 220 are provided with a mechanism that can be combined with each other, and are connected to the body 210, so as to wear the body 210 on a wearer's wrist. The plug-in power supply 230 is provided with a carrier 231, at least one second battery 232 disposed in the carrier 231, and a connector 233 disposed in the carrier 231 and electrically connected to the second battery 232. In the present embodiment, the carrier 231 is C-shaped and is elastic, allowing it to wear on wrists of different thicknesses. Meanwhile, the carrier 231 is outwardly defined with a groove 235 extending towards both ends thereof and having a window hole 236 facing the sensor 213. The body 210 and the strap 220 are embedded in the groove 235 so as to be kept on the carrier 231. The configured wearable electronic device 200 can also allow the first battery 211 to absorb the electric power from the second battery 232 when the connector 233 is connected to the connecting port 212. In the present embodiment, the connecting port 212 is disposed at the bottom of body 210, the connector 233 is disposed in the groove 235 of the carrier 231, when the body 210 is embedded in the groove 235 and fixed to the carder 231, the connector 233 will be connected to the connecting port 212 simultaneously.

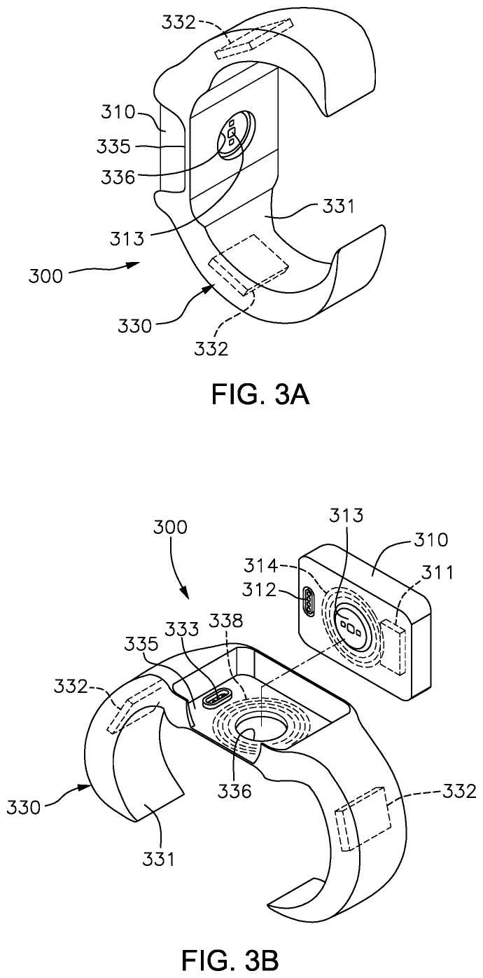

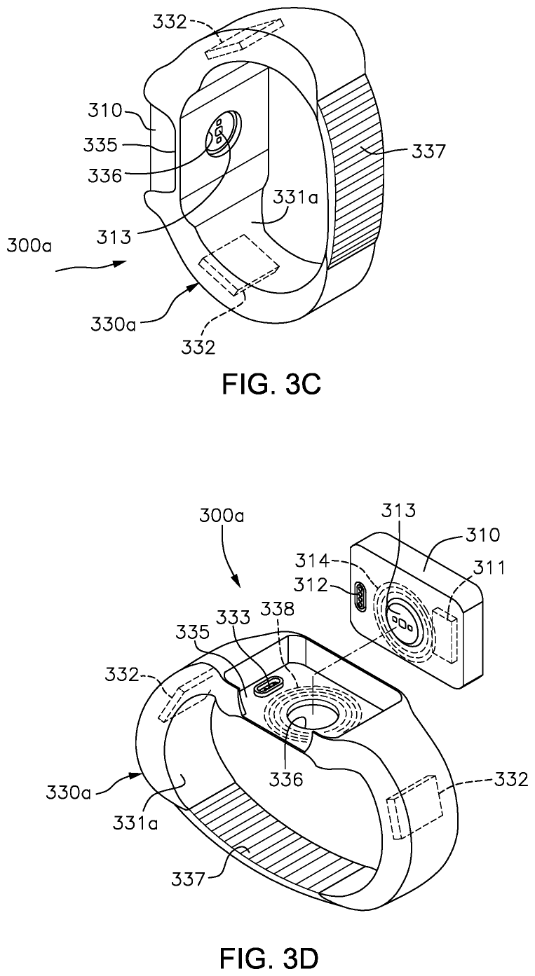

Referring to FIGS. 3A and 3B, a wearable electronic device 300 in accordance with a third embodiment of the present invention comprises a body 310 and a plug-in power supply 330, The body 310 is provided with a first battery 311, a connecting port 312 electrically connected to the first battery 311 and a sensor 313. The plug-in power supply 330 is provided with a C-shaped and elastic carder 331 suitable for wearing on a wearer's wrist, at least one second battery 332 disposed in the carrier 331, and a connector 333 disposed in the carder 331 and electrically connected to the second battery 332. In the middle of the carrier 331 is defined a recess 335 having a window hole 336 facing the sensor 313. When the body 310 is embedded in the recess 335 and fixed to the carrier 331, the connector 333 will be connected to the connecting port 312 simultaneously, such that the electric power of the second battery 332 is transmitted to the first battery 311.

Referring to FIGS. 3C and 3D, the difference between a wearable electronic device 300a disclosed in this embodiment and that of FIGS. 3A and 3B is a carder 331a, and the rest are exactly the same, so the same parts as FIGS. 3A and 3B are marked with the same symbols and the previous description of FIGS. 3A and 3B is applicable to this embodiment and will not be repeated. In the present embodiment, the carrier 331a is made of a material of moderate hardware and software, such as, silicone, thermoplastic polyurethane elastomer rubber (TPU) and so on, so as to form a ring structure with a telescopic band 337 for easy to wear on a wearer's wrist.

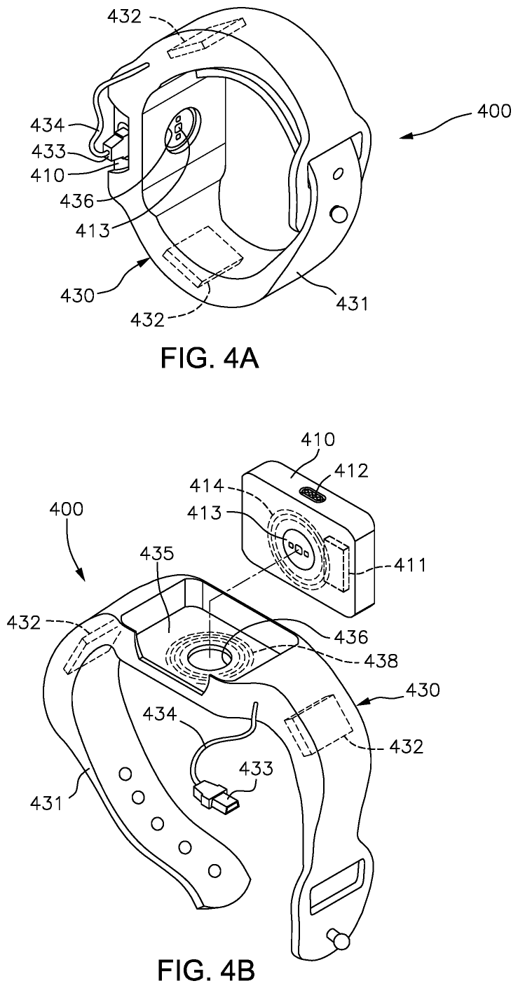

Referring to FIGS. 4A and 4B, a wearable electronic device 400 in accordance with a fourth embodiment of the present invention comprises a body 410 and a plug-in power supply 430. The body 410 is provided with a first battery 411, a connecting port 412 electrically connected to the first battery 411 and a sensor 413. The plug-in power supply 430 is provided with a carrier 431, at least one second battery 432 disposed in the carrier 431, and a connecting line 434 disposed in the carrier 431 and electrically connected to the second battery 432, a free end of the connecting line 434 is provided with a connector 433. Both ends of the carrier 431 are provided with a mechanism that can be combined with each other, allowing it to wear on a wearer's wrist. In the middle of the carrier 431 is defined a recess 435 having a window hole 436 facing the sensor 413. When the body 410 is embedded in the recess 435 and fixed to the carrier 431, the connector 433 will be connected to the connecting port 412 simultaneously, allowing the first battery 411 to absorb the electric power from the second battery 432.

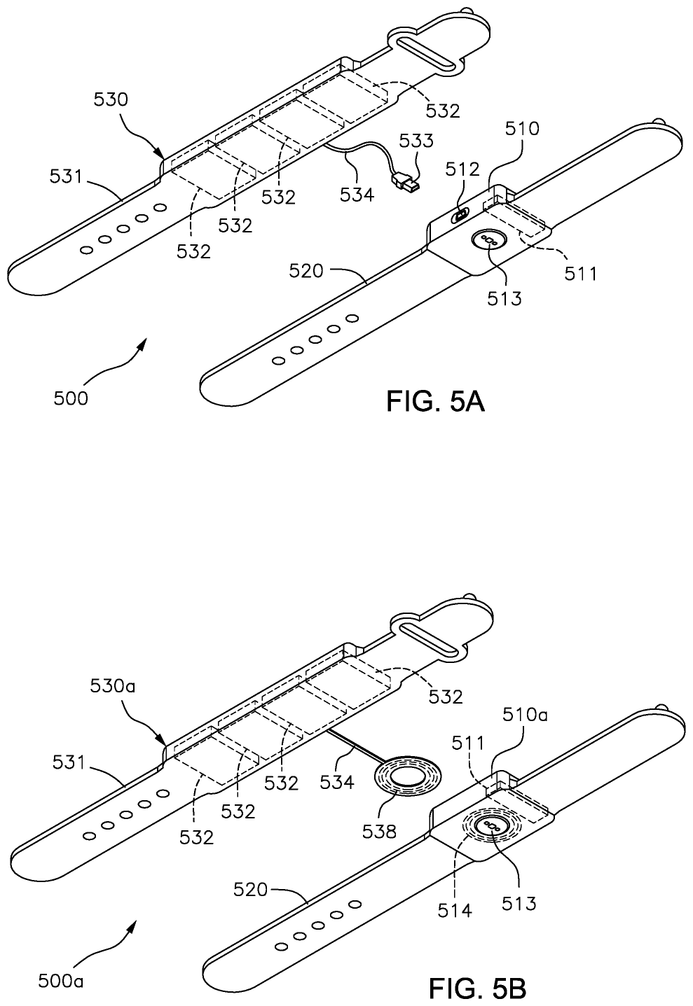

Referring to FIG. 5A, a wearable electronic device 500 in accordance with a fifth embodiment of the present invention comprises a body 510, a strap 520 and a plug-in power supply 530. The body 510 is provided with a first battery 511, a connecting port 512 electrically connected to the first battery 511 and a sensor 513. Both ends of the strap 520 are provided with a mechanism that can be combined with each other, and are connected to the body 510, so as to wear the body 510 on a wearers wrist. The plug-in power supply 530 is provided with a carrier 531, at least one second battery 532 disposed in the carrier 531, and a connector 533 disposed in the carrier 531 and electrically connected to the second battery 532. The plug-in power supply 530 is worn on a wearers wrist through the carrier 531 and kept on one side of the body 510, so that when the connector 533 is connected to the connecting port 512, the electric power of the second battery 532 is transmitted to the first battery 511. The strap 520 and the carder 531 can also be formed as the above-mentioned carder 331/331a/431.

For the wearable electronic device 100/200/300/300a/400/500 disclosed in the above embodiments, the first battery 111/211/311/411/511 absorbs the electric power from the second battery 132/232/3321432/532 by connecting the connector 133/233/333/433/533 to the connecting port 112/212/312/412/512. The connector 133/233/333/433/533 and the connecting port 112/212/312/412/512 may be any type of transmission interface, unrestricted by a specific interface.

The present invention may also transmit the electric power by an inductive charging mode. That is, in some embodiments of the present invention, as shown in FIGS. 1B/2B/3B/3D/4B/5B, the body 110/210/310/410/510a may carry a first induction coil 114/214/314/414/514 to replace the connecting port 112/212/312/412/512, the plug-in power supply 130/230/330/330a/430/530a may utilize a second induction coil 138/238/338/438/538 to replace the connector 133/233/333/433/533. Thus, the second induction coil 138/238/338/438/538 will generate a magnetic field around it as the current flows through it, which generates an induction current on the first induction coil 114/214/314/414/514 through electromagnetic induction that is directed to the first battery 111/211/311/411/511, thereby achieving the inductive charging effect to supplement the electric power consumed by the first battery 111/211/311/411/511. It should be noted that the wearable electronic device 100/200/300/300a/400 will not have both contact charging and inductive charging modes, and the two charging modes will be implemented separately. However, in order to reduce the number of figures, the two charging modes are Illustrated in FIGS. 1B/2B/3B/3D/4B simultaneously. The second induction coil 138/238/338/438/538 may also receive a current from a wireless charger (not shown), so as to supplement the electric power consumed by the second battery 132/232/332/432/532. In the embodiment of FIG. 5A or 5B, since the plug-in power supply 530 or 530a, and the strap 520 are worn on a wearer's wrist parallelly, the connector 533 or the second induction coil 538 must extend outside the carrier 531 via a connecting line 534 to facilitate coupling to the connecting port 512 or the first induction coil 514. For simplification, the parts of FIG. 5B that are the same as those of FIG. 5A are marked with the same symbols, and previous description of FIG. 5A also applies to FIG. 5B and will not be repeated.

Since the acceptable battery size, quantity and weight of the plug-in power supply 130/230/330/300a/430/530/530a are less limited, the high battery capacity and strong endurance can meet the needs of a large or long time of use.

It should be noted that when the plug-in power supply 130/230/330/300a/430/530/530a is described as an independent claim, the description of the first battery 111/211/311/411/511 and the first induction coil 114/214/314/414/514 will omit the term “first”, only shown as the battery and the induction con, respectively.

While we have shown and described various embodiments in accordance with the present invention, it should be clear to those skilled in the art that further embodiments may be made without departing from the scope of the present invention.

What is claimed is:

1. A plug-in power supply for a wearable electronic device, comprising:
a carrier being worn on a wearer's wrist;
at least one battery being disposed in the carrier; and
an induction coil or a connector being disposed in the carrier or extended outside the carder and electrically connected to the battery, the induction coil or the connector transmitting electric power to the wearable electronic device;
wherein the carder is one of the following carriers a to f:
a. the carder is belt-shaped, both sides of the carder are defined with a perforating hole, respectively, the wearable electronic device passes through the perforating holes to overlap with the carder, so as to be kept on the carder;
b. the carder is C-shaped and is outwardly defined with a groove extending towards both ends thereof, the wearable electronic device is embedded in the groove so as to be kept on the carder;
c. the carder is C-shaped and is defined with a recess in the middle thereof, the wearable electronic device is embedded in the recess so as to be kept on the carder;
d. the carder is ring-shaped and is defined with a recess in the middle thereof, the wearable electronic device is embedded in the recess so as to be kept on the carrier;
e. the carder is C-shaped, and is provided with mechanisms that can be combined with each other in both ends thereof and a recess in the middle thereof, the wearable electronic device is embedded in the recess so as to be kept on the carrier; and
f. the carrier is belt-shaped and is provided with mechanisms that can be combined with each other in both ends thereof.

2. The plug-in power supply for a wearable electronic device as claimed in claim 1, wherein one of the carriers a to e is defined with a window hole facing a sensor of the wearable electronic device.

3. A wearable electronic device, comprising:
a body having a first battery and a first induction coil or a connecting port electrically connected to the first battery;
a strap being connected to the body, so as to wear the body on a wearer's wrist; and
a plug-in power supply including a carrier worn on the wearer's wrist, at least one second battery being disposed in the carrier, and a second induction coil or a connector being disposed in the carrier or extends outside the carder and electrically connected to the second battery, the second induction coil or the connector transmitting electric power of the second battery to the first induction coil or the connecting port, so as to supplement the electric power of the first battery;
wherein the carder is one of the following carriers a to c:
a. the carder is belt-shaped, both sides of the carder are defined with a perforating hole, respectively, both ends of the strap pass through the perforating holes to overlap with the carder, so as to make the body kept on the carder;
b. the carder is C-shaped and is outwardly defined with a groove extending towards both ends thereof, the body and the strap are embedded in the groove so as to be kept on the carrier; and
c. the carrier is belt-shaped and is provided with mechanisms that can be combined with each other in both ends thereof.

4. The wearable electronic device as claimed in claim 3, wherein the body is provided with a sensor, the carrier of a or bis defined with a window hole facing the sensor.

5. A wearable electronic device, comprising:
a body having a first battery and a first induction coil or a connecting port electrically connected to the first battery; and
a plug-in power supply including a carrier worn on a wearer's wrist, at least one second battery being disposed in the carder, and a second induction coil or a connector being disposed in the carrier or extends outside the carder and electrically connected to the second battery, the second induction coil or the connector transmitting electric power of the second battery to the first induction coil or the connecting port, so as to supplement the electric power of the first battery;
wherein the carder is one of the following carriers a to c:
a. the carder is C-shaped and is defined with a recess in the middle thereof, the body is embedded in the recess so as to be kept on the carder;
b. the carder is ring-shaped and is defined with a recess in the middle thereof, the body is embedded in the recess so as to be kept on the carder; and
c. the carder is C-shaped, and is provided with mechanisms that can be combined with each other in both ends thereof and a recess in the middle thereof, the body is embedded in the recess so as to be kept on the carrier.

6. The wearable electronic device as claimed in claim 5, wherein the body is provided with a sensor, the carrier of a or b or cis defined with a window hole facing the sensor.
